(19) United States
(12) Patent Application Publication
(10) Pub. No.: US 2014/0100906 A1
(43) Pub. Date: Apr. 10, 2014

(54) METHODS FOR CHARACTERIZING PERFORMANCE OF AN ENERGY-EFFICIENT FILM IN FENESTRATION ASSEMBLIES

(71) Applicant: CLEAR WALL CORPORATION, FELTON, CA (US)

(72) Inventor: Normand MARCHAND, Felton, CA (US)

(73) Assignee: CLEAR WALL CORPORATION, FELTON, CA (US)

(21) Appl. No.: 14/046,471

(22) Filed: Oct. 4, 2013

Related U.S. Application Data
(60) Provisional application No. 61/709,824, filed on Oct. 4, 2012.

(51) Int. Cl. G01N 21/59; G06Q 10/06; G01N 25/00

(52) U.S. Cl. CPC G01N 21/59; G01N 25/00; G06Q 10/06313
USPC 705/7.23; 374/45; 356/72

(57) ABSTRACT

A method of determining energy performance of a film component is disclosed. The method includes: (i) obtaining a glass heat loss value or a glass heat gain value of a glass body by measuring heat loss or heat gain from the glass body using a heat distribution measuring device; (ii) obtaining an assembly heat loss value or an assembly heat gain value of a film and glass assembly by measuring heat loss or heat gain from the film and glass assembly using a heat distribution measuring device; (iii) obtaining an assembly heat loss value or an assembly heat gain value of a film and glass assembly by measuring heat loss or heat gain from the film and glass assembly using a heat distribution measuring device; and (iv) subtracting the glass heat loss value from the assembly heat loss value to obtain a film heat loss value or subtracting the glass heat gain value from the assembly heat gain value to obtain a film heat gain value

### RELATED APPLICATIONS

The present application claims priority from U.S. Provisional Application Ser. No. 61/709,824, which was filed on Oct. 4, 2012, which is incorporated herein by reference for all purposes.

### FIELD

The present teachings relate generally to performance of fenestration assemblies. More particularly, the present teachings relate to methods of characterizing the performance of a substrate, such as energy-efficient film, that is secured over a window frame cavity by a fenestration assembly.

### BACKGROUND

Fenestration means products that fill openings in a building envelope, such as windows, doors, skylights, curtain walls, etc., that are designed to permit the passage of air, light, vehicles, or people. A building envelope, in turn, generally refers to the separation between the interior and the exterior environments of a building. It serves as the outer shell to protect the indoor environment as well as to facilitate its climate control.

In order to increase a building's energy efficiency, and to decrease the loads on a building's air conditioning and heating systems, fenestration assemblies are used to cover the interior of a building's window frame cavity with transparent window film. By way of example, using such a window/film combination in the winter season causes interior light to reflect back inside, trapping a relatively greater amount of heat inside the building envelope. Conversely, in the summer season, a relatively large amount of exterior light is reflected back to the exterior of the building, allowing cooler temperatures to prevail inside the building envelope. Further, use of such fenestration assemblies to cover the interior of a building's window frame cavity, rather than covering the window frame cavity with drapes, blinds, shades or the like, permits entry of natural light into a building envelope and provides a view outside for the building envelope's occupants.

What is therefore needed are methods for characterizing performance of films in fenestration assemblies that are faster and more accurate than conventional techniques.

### SUMMARY

In one aspect, the present teachings provide a method of determining energy performance of a film component. The method comprises the following steps: (1) obtaining a glass heat loss value or a glass heat gain value of a glass body by measuring heat loss or heat gain from the glass body using a heat distribution measuring device; (2) obtaining an assembly heat loss value or an assembly heat gain value of a film and glass assembly by measuring heat loss or heat gain from the film and glass assembly using a heat distribution measuring device; and (3) subtracting the glass heat loss value from the assembly heat loss value to obtain a film heat loss value or subtracting the glass heat gain value from the assembly heat gain value to obtain a film heat gain value; wherein the film and glass assembly includes a film component and a glass component, the film component directly contacts the glass component or is a certain distance off from the glass component and the glass component is the same as or similar to the glass body, and the film heat loss value or the film heat gain value represent an energy performance value of the film. Preferably, the film component is secured on a fenestration assembly. The glass body is preferably one material selected from group consisting of glass, fiberglass and spanger.

In preferred embodiments of the present teachings, the heat distribution measuring device is a thermography unit. Heat loss or heat gain preferably has units of kilowatt/square foot or therms/square foot.

In another aspect, the present teachings provide a method of determining energy savings from a film. The method comprises the following steps: (1) obtaining a glass heat loss value or a glass heat gain value of a glass body by measuring heat loss or heat gain from the glass body using a heat distribution device; (2) obtaining an assembly heat loss value or an assembly heat gain value of a film and glass assembly by measuring heat loss or heat gain from the film and glass assembly, and in the film and glass assembly; (3) subtracting the glass heat loss value from the assembly heat loss value to obtain a film heat loss value or subtracting said glass heat gain value from said assembly heat gain value to obtain a film heat gain value; and (4) multiplying the film heat gain value or said film heat loss value with a price per unit of energy to obtain a money savings from heat gain value or a money savings from heat loss value; and wherein the film and glass assembly includes a film component and a glass component, the film component directly contacts said glass component or is a certain distance off from the glass component and the glass component is same as or similar to the glass body, and wherein the money savings from heat gain value or money savings from heat loss value represent energy savings realized from a film. Preferably, the film component is secured on a fenestration assembly.

In preferred embodiments of the present teachings, the method further comprises determining a payback period for cost of purchasing and installing the fenestration assembly based upon the money savings from heat gain value or money savings from heat loss value. In alternate embodiments of the present teachings, the method further comprises determining a lease period for leasing the fenestration assembly based upon cost of purchasing and installing the fenestration assembly and money savings from heat gain value or money savings from heat loss value. In other alternate embodiments of the present teachings, the method further comprises determining a lease period for leasing the fenestration assembly based on the payback period.

In another aspect, the present teachings provide a method of determining luminous efficacy of a glass component and a film component assembly. The method comprises the following steps: (1) obtaining an assembly visible light transmission value of an assembly of a glass body component and a film component by measuring visible light transmission through the assembly using a visible light transmission measuring device; (2) obtaining an assembly heat transmission value of the assembly or another assembly of the glass body component or another glass body component and the film component or another film component by measuring heat transmission through the assembly or another assembly using a heat distribution measuring device; (3) dividing the assembly visible light transmission value with the assembly heat transmission value to determine an assembly luminous efficacy value; and wherein another assembly is substantially similar to the assembly. Preferably, the visible light transmission measuring device is a candle meter, and the heat distribution measuring device is thermography unit.

In preferred embodiments of the present teachings, a method of determining luminous efficacy of a film component includes further steps of: (1) obtaining another assembly heat transmission value of a second assembly of a second glass body component and a second film component by measuring heat transmission through the second assembly using a heat distribution measuring device; and (2) multiplying another assembly heat transmission value with the assembly luminous efficacy value to determine another assembly visible light transmission value; and wherein in the second assembly, the second glass body component is same as or substantially similar to the glass body component or another glass body component, and the second film component is same as or substantially similar to the film component or another film component, and the second assembly is of same or of substantially similar configuration as the assembly or another assembly.

In preferred embodiments of the present teachings, a method of determining luminous efficacy of a film component includes further steps of: (1) obtaining another assembly visible light transmission value of a second assembly of a second glass body component and a second film component by measuring visible light transmission through the second assembly using a visible light transmission measuring device; (2) and multiplying another assembly visible light transmission value with the assembly luminous efficacy value to determine another assembly heat transmission value; and wherein in the second assembly, the second glass body component is same as or substantially similar to the glass body component or another glass body component, and the second film component is same as or substantially similar to the film component or another film component, and the second assembly is of same or of substantially similar configuration as the assembly or another assembly.

The methods of the present teachings, however, together with additional steps and advantages thereof, will be best understood from the following descriptions of specific embodiments when read in connection with the accompanying figures.

### BRIEF DESCRIPTION OF THE DRAWINGS

FIG. 1 shows a flowchart of a method, according one preferred embodiment of the present teachings, for determining energy performance of a film component.

FIG. 2 shows a flowchart of a method, according to one preferred embodiment of the present teachings, for determining energy savings of a film component.

FIG. 3 shows a flowchart of a method, according to one preferred embodiment of the present teachings, for determining luminous efficacy of a film component.

### DETAILED DESCRIPTION OF THE PREFERRED EMBODIMENTS

In the following description numerous specific details are set forth in order to provide a thorough understanding of the present teachings. It will be apparent, however, to one skilled in the art that the present teachings may be practiced without limitation to some or all of these specific details. In other instances, well known process steps have not been described in detail in order to not unnecessarily obscure the present teachings.

The present teachings offer methods of determining the energy performance and energy savings of film components used in fenestration assemblies. Such fenestration assemblies are useful in coupling a film component, preferably transparent window film, which imparts energy savings, to a window. The teachings disclosed herein rapidly and accurately measure the energy performance and energy savings of such a window/film component.

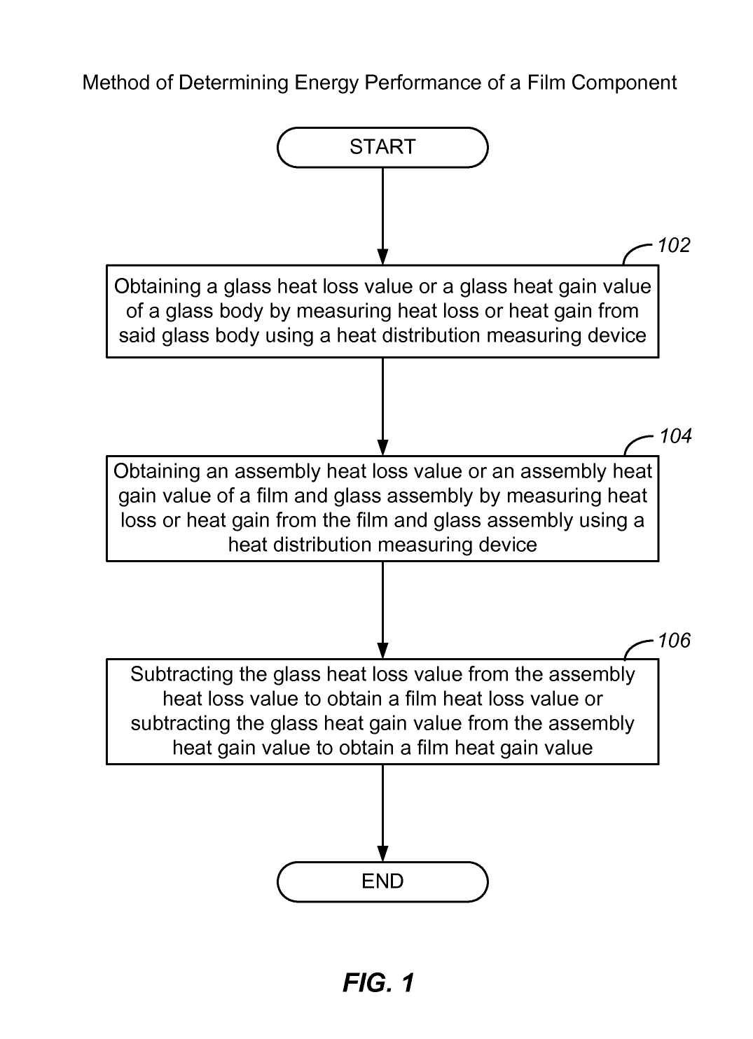

FIG. 1 is a flowchart showing certain salient steps for a method, according to one preferred embodiment of the present teachings, for determining energy performance of a film component. The process of FIG. 1 begins with a step 102, which includes obtaining a glass heat loss value or a glass heat gain value of a glass body by measuring heat loss or heat gain from the glass body using a heat distribution measuring device. In preferred embodiments of the present teachings, the glass body includes one material selected from a group consisting of glass, fiberglass, and spanger. The glass body may be a window that provides a relatively transparent barrier between the interior and the exterior of a building envelope.

According to the present teachings, heat gain value or heat loss value of a glass body is measured using a heat distribution device. Preferably, the heat distribution measuring device comprises a thermography unit, i.e., a thermal imaging device capable of measuring the rate of radiation emission through a glass body. More preferably, the heat distribution measuring device is a commercially available thermal imager from Fluke Corporation, located in Everett, Wash., or a commercially available thermal imager from FLIR Systems in Boston, Mass. Measurement of heat gain value or heat loss value of a glass body using a thermography unit may be thought of as a “real-time” measurement of heat gain value or heat loss value.

The present teachings recognize that the value of a rate of radiation emission through a window correlates with a value of heat gain or heat loss through that window. To this end, a heat distribution measuring device represents a means of obtaining a value of heat gain or a value of heat loss through a glass body. Typically, the heat distribution measuring device provides an output of heat gain or heat loss. The present teachings, however, contemplate that the output of the heat distribution measuring device may be converted to a value of kilowatts/square foot or therms/square foot using techniques well-known to those skilled in the art. By way of example, raw values of heat gain or heat loss measured from a thermal imaging device may be input to computer software that is programmed to generate an output of heat gain or heat loss.

The present teachings recognize that kilowatt-hours/square foot corresponds to electricity usage, and therms/square foot corresponds to gas usage. In either case, the heat distribution measuring device is used to obtain, either directly or indirectly, a value of heat loss or heat gain through a glass body.

To carry out step 102, a heat distribution measuring device, e.g., a FLIR or Fluke thermal imager described above, is pointed at a glass body from the interior of a building, and a value of heat loss or heat gain is obtained. Such a measurement is typically obtained in a relatively brief period of time, i.e., a few seconds. As a result, the present teachings realize the advantage of obtaining values of heat loss and heat gain relatively quickly. Further, use of heat distribution measuring devices contemplated by the present teachings provides a “real-time” measurement of values of heat loss or heat gain. In certain preferred embodiments of the present teachings, a heat distribution measuring device includes or is coupled to at least one sensor that is placed inside a building envelope and that is capable of measuring heat gain or heat loss at any time.

Next, a step 104 includes obtaining an assembly heat loss value or an assembly heat gain value of a film and glass assembly by measuring heat loss or heat gain from the film and glass assembly using the above-mentioned heat distribution measuring device. In preferred embodiments of the present teachings, the film and glass assembly includes a transparent window film capable of imparting energy savings by preventing either heat gain or heat loss through a glass body, e.g., the glass body of step 102. Film is preferably coupled to glass with a fenestration assembly, providing a distance between the film and glass. In alternate embodiments of the present teachings, however, film is attached directly to glass.

Step 104, i.e., obtaining the assembly heat loss value or the assembly heat gain value of the film and glass assembly, is carried out in a substantially similar manner to the step of obtaining the glass heat loss value or the glass heat gain value, respectively, described above with reference to step 102. In certain embodiments of the present teachings, to ensure the accuracy of measurement of energy performance and energy savings (described in further detail below), the measurement carried out in step 104 should be done at approximately the same time as the measurement carried out in step 102. Further, the present teachings contemplate that the values obtained in steps 102 and 104 may be obtained during various times or during different seasons and then averaged to arrive at a more accurate measurement of heat gain or heat loss throughout a given time period.

Next, a step 106 includes subtracting the glass heat loss value from the assembly heat loss value to obtain a film heat loss value; or subtracting the glass heat gain value from the assembly heat gain value to obtain a film heat gain value. Accordingly, a glass heat loss value obtained from step 102 above is subtracted from an assembly heat loss value obtained in step 104 above to obtain a film heat loss value. Alternatively, a glass heat gain value obtained from step 102 above is subtracted from an assembly heat gain value obtained in step 104 above to obtain a film heat gain value. Thus, the value obtained in step 106 represents the difference in heat loss or heat gain between a window not coupled to window film and a window coupled to window film. In other words, step 106 provides a value of energy efficiency gained, preferably in units of kilowatts/square foot or therms/square foot, by the presence of window film. In preferred embodiments of the present teachings, performance of a film component is tied to its use in an assembly with a particular glass body component (e.g., a window).

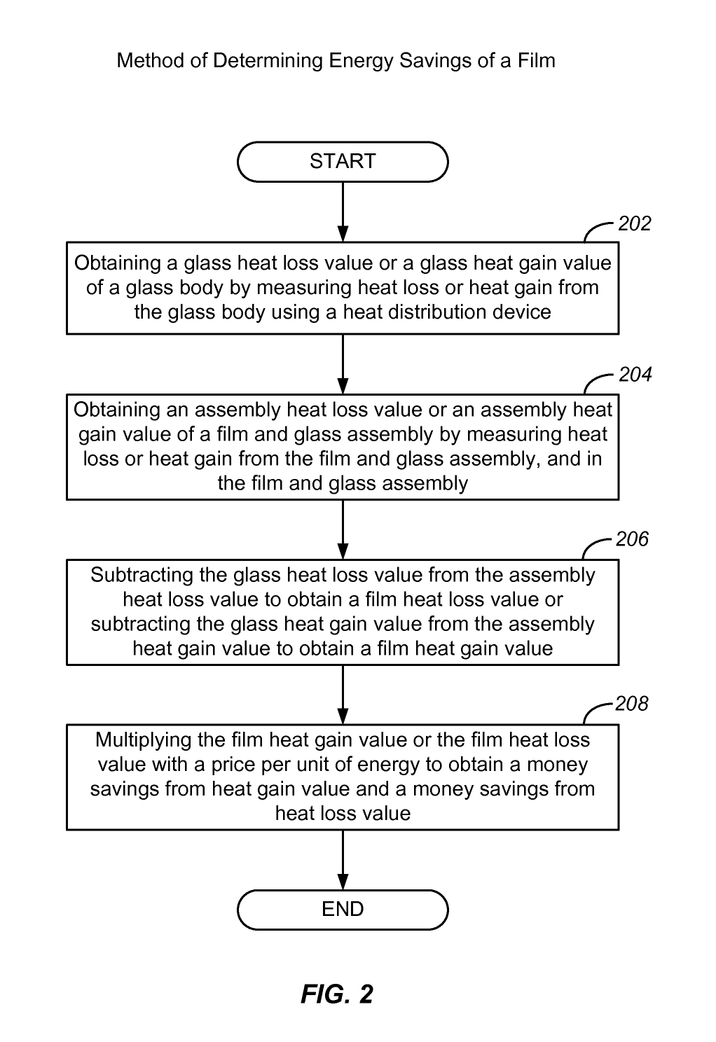

FIG. 2 is a flowchart showing certain salient steps for a method, according to one embodiment of the present teachings, for determining energy savings of a film. Steps 202, 204, and 206, are substantially similar to and carried out in a substantially similar manner as their respective counterparts in steps 102, 104, and 106 of FIG. 1.

Next, a step 208 includes multiplying the film heat gain value or the film heat loss value with a price per unit of energy to obtain a money savings from heat gain value or a money savings from heat loss value. In other words, the value of energy efficiency obtained in step 206 is converted to a value for money savings using a price per unit energy that may be pre-determined. In this manner, the present teachings recognize that heat gain or heat loss values obtained according to the present teachings may be used to determine energy savings that result from coupling of window film to a window.

In preferred embodiments of the present teachings, the value of money savings obtained from step 208 is used to determine a payback period for the cost of purchasing and installing a fenestration assembly. In such embodiments, the cost of purchasing and installing a fenestration assembly may be pre-determined. Once a value of money savings is obtained from use of such a fenestration assembly, e.g., according to step 208 of FIG. 2, a period of time sufficient to produce money savings equal to the cost of purchasing and installing a fenestration assembly, which represents a “payback period,” is determined. By way of example, if the cost in dollars of purchasing and installing a fenestration assembly is represented by a value of “X,” and the money savings obtained from step 208 of FIG. 2 is represented by a value of “Y,” where Y is expressed in units of dollars/month, then the payback period, in months, for purchasing a fenestration assembly is calculated by the following expression, X/Y. In alternate embodiments of the present teachings, the payback period is extended where only a portion of money savings obtained by use of a fenestration assembly is contributed to the cost of purchasing and installing a fenestration assembly. In such embodiments, the payback period represent a longer period of time than a payback period determined where all money savings realized from use of window film contributes to the cost of purchasing and installing a fenestration assembly.

In a similar manner, certain embodiments of the present teachings are used to determine a “lease period” for leasing a fenestration assembly based upon the cost of purchasing and installing the fenestration assembly and money savings gained by use of the fenestration assembly. In such embodiments, the lease value is calculated, and the lease period is determined in a substantially similar manner to the determination of a payback period described above. Accordingly, the money savings determined from heat gain value or heat loss value (e.g., from step 208 above), are applied to the pre-determined lease value. In alternate embodiments of the present teachings, a lease period is calculated based on the payback period determined above. It is important to note that it is not necessary to use a thermography unit to determine film heat gain or loss values, or to obtain real-time measurements. In certain embodiments of the present teachings, conventional techniques (e.g., measurement and verification), such as taking meter readings from HVAC units or data loggers are used to determine film heat gain or loss values. Next, step 208 is carried out as mentioned above to arrive at money savings from heat gain values or money savings from heat loss values. These values may then be used to determine a payback period or a lease period as described above.

The present teachings provide the advantage of using a window/film assembly either to increase heat loss in a building envelope when temperatures are relatively high, or to increase heat gain in a building envelope when temperatures are relatively low. Thus, temperatures inside a building envelope are adjusted without the need to obstruct a window frame cavity with drapes, blinds, shades, or the like. The present teachings therefore provide the further advantage of adjusting temperatures inside a building envelope while at the same time allowing for the passage of natural light inside the building envelope. As a result, energy savings are realized, because transmission of natural light inside a building envelope results in a need for less energy to be used to provide artificial light to the building envelope's occupants. Further, because there is no need to obstruct a window frame cavity, the building envelope's occupants are able to enjoy the benefits of natural light inside the building envelope, as well as a view outside the building envelope.

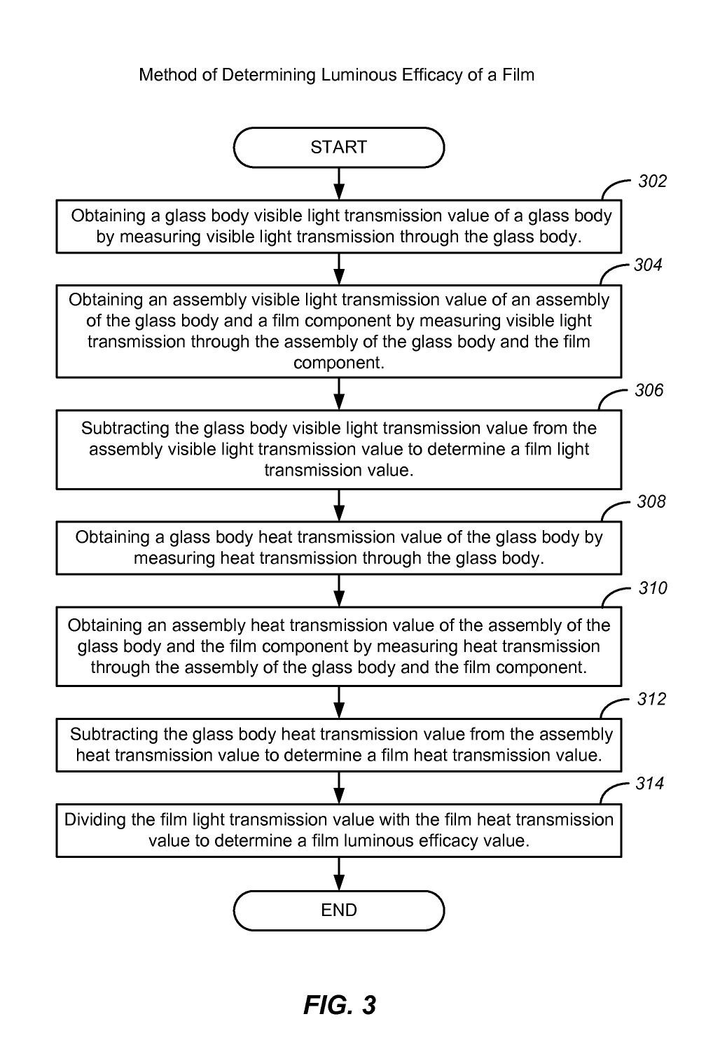

To account for the efficacy of light transmission relative to heat transmission through a window/film assembly into a building envelope (i.e., daylighting), a value for “luminous efficacy” of a film component is determined by the ratio of visible light transmission through the film component to heat transmission (i.e., heat loss or heat gain) through the film component. To this end, FIG. 3 shows certain salient steps, according to one preferred embodiment of the present teachings, of a process 300 for calculating a luminous efficacy of a film component. Process 300 begins with a step 302, which includes obtaining a glass body visible light transmission value of a glass body by measuring intensity of visible light transmitted through the glass body. Preferably, a visible light transmission value is measured using a visible light transmission measuring device, such as a candle meter, capable of reading illuminance of visible light that is transmitted. The units of intensity of light measurements are typically reported in candles, and luminance is typically reported in candles of square meter.

Next, a step 304 includes obtaining an assembly visible light transmission value of an assembly of the same or substantially similar glass body component and a film component by measuring visible light transmission through the assembly using techniques that are similar to those described in step 302.

Next, a step 306 includes subtracting the glass body visible light transmission value from the assembly visible light transmission value to determine a film visible light transmission value. Thus, according to the present teachings, step 306 is preferably used to account for the difference in light transmission between a window and a window/film assembly. In other words, step 306 accounts for the difference in visible light transmission attributable to the film component of a window/film assembly.

Next, a step 308 includes obtaining a glass body heat transmission value of the glass body by measuring heat transmission through the glass body. Step 308 is substantially similar to its counterparts, step 102 of FIG. 1 and step 202 of FIG. 2. Preferably, measuring heat transmission is carried out using a heat distribution measuring device, such as a thermal imager, thermography unit, or an infrared (“IR”) camera.

Next, a step 310 includes obtaining an assembly heat transmission value of the assembly of the same or substantially similar glass body component and the same or substantially similar film component by measuring heat transmission through the window/film assembly. Step 310 is substantially similar to its counterparts, step 104 of FIG. 1 and step 204 of FIG. 2. In those embodiments that use a substantially similar glass body component and/or a substantially similar film component, the window/film configuration is substantially similar to the window/film configuration used in step 304. According to the present teachings, the film component either directly contacts the glass body component or is a certain distance off from the glass body component.

Next, a step 312 includes subtracting the glass body heat transmission value from the assembly heat transmission value to determine a film heat transmission value. As in step 306 above with respect to determining a light transmission value, step 312 is preferably used to account for the difference in heat transmission attributable to the coupling of window film to a window.

Next, a step 314 includes dividing the film light transmission value determined in step 306 with the film heat transmission value determined in step 312 to determine a film luminous efficacy value. In other words, step 314 is used to determine a value of luminous efficacy that is associated with a particular film. In preferred embodiments of the present teachings, however, a luminous efficacy of a film is associated with the particular window used in the window/film assembly during the above-described obtaining steps.

In preferred embodiments of the present teachings, a luminous efficacy of a window/film assembly is determined using similar steps as those described above with reference to FIG. 3. In such embodiments, determining a luminous efficacy of a window/film assembly includes a first step that is substantially similar to step 304 of FIG. 3, i.e., obtaining an assembly visible light transmission value of a window/film assembly using a visible light transmission measuring device.

Next, a second step, which is substantially similar to step 310 of FIG. 3, includes obtaining an assembly heat transmission value of the window/film assembly or another window/film assembly using a heat distribution measuring device. In those embodiments that use another window/film assembly, the window and film components of another window/film assembly are substantially similar to the window and film components used in the window/film assembly of the previous step, and are in a substantially similar assembly configuration as the window/film configuration of the previous step.

Next, a third step, which is substantially similar to step 314 of FIG. 3, includes dividing the assembly visible light transmission value with the assembly heat transmission value to determine an assembly luminous efficacy value. In such manner, the efficacy of light transmission through a window/film assembly relative to heat transmission through the window/film assembly is determined.

According to one embodiment of the present teachings, luminous efficacy represents a value that is a constant value for a particular or a substantially similar window/film assembly. Thus, when a luminous efficacy value for a window/film assembly is known, differences in visible transmission of light through the same or a substantially similar window/film assembly (e.g., due to periods of increased or decreased transmission of sunlight through a window/film assembly) may be accounted for by determining heat gain or heat loss through the same or a substantially similar window/film assembly (e.g., according to the methods described above with respect to FIGS. 1 and 2).

By way of example, according to preferred embodiments of the present teachings, an assembly luminous efficacy value of a window/film assembly, which is a relatively constant value for a same or a substantially similar window/film assembly, is first determined according to the methods described above, where assembly luminous efficacy=assembly heat transmission/assembly visible light transmission. Next, an assembly heat transmission value of a second window/film assembly comprising a second glass body component and a second film component is measured using a heat distribution measuring device. According to the present teachings, the second glass body component and the second film component are the same as or substantially similar to the glass body component and the film component used to determine a luminous efficacy value of the window/film assembly; likewise, the configuration of the second window/film assembly is in the same or a substantially similar configuration as the window/film assembly used to determine a luminous efficacy value of the window/film assembly. Next, an assembly heat transmission value of the second window/film assembly is obtained using methods substantially similar to those described above with reference to step 104 of FIG. 1 and step 204 of FIG. 2. Finally, the assembly heat transmission value of the second window/film assembly is multiplied by the luminous efficacy value determined above to determine the visible light transmission value of the second window/film assembly. In such manner, a constant value of assembly luminous efficacy for a window/film assembly and a measured value of heat transmission value for a same or a substantially similar window/film assembly are used to determine an assembly light transmission value for the same or a substantially similar window/film assembly.

In a similar manner, according to preferred embodiments of the present teachings, when an assembly luminous efficacy value is known, differences in transmission of heat through the same or a substantially similar window/film assembly may also be accounted for by determining changes in visible light transmission through the same or a substantially similar window/film assembly. In doing so, an assembly luminous efficacy value is first determined as described in the previous example. Next, an assembly visible light transmission value of a second assembly (which, as in the previous example, is the same as or substantially similar to the window/film assembly used to determine an assembly luminous efficacy value) is measured using methods substantially similar to those described above with reference to step 304 of FIG. 3. Finally, the assembly visible light transmission value of the second assembly is divided by the assembly luminous efficacy value determined above to determine the assembly heat transmission value of the second assembly. Thus, a constant value of assembly luminous efficacy for a window/film assembly and a measured assembly heat transmission value of a same or substantially similar window/film assembly are used to determine an assembly light transmission value of the same or a substantially similar window/film assembly.

Although illustrative embodiments of the present teachings have been shown and described, other modifications, changes, and substitutions are intended. Accordingly, it is appropriate that the appended claims be construed broadly and in a manner consistent with the scope of the disclosure, as set forth in the following claims.

What is claimed is:

1. A method of determining energy performance of a film component, said method comprising:
obtaining a glass heat loss value or a glass heat gain value of a glass body by measuring heat loss or heat gain from said glass body using a heat distribution measuring device;
obtaining an assembly heat loss value or an assembly heat gain value of a film and glass assembly by measuring heat loss or heat gain from said film and glass assembly using said or another heat distribution measuring device;
subtracting said glass heat loss value from said assembly heat loss value to obtain a film heat loss value or subtracting said glass heat gain value from said assembly heat gain value to obtain a film heat gain value; and
wherein said film and glass assembly includes a film component and a glass component, said film component directly contacts said glass component or is a certain distance off from said glass component and said glass component is same as or similar to said glass body, and said film heat loss value or said film heat gain value represent an energy performance value of said film.

2. The method of claim 1, wherein said film component is secured on a fenestration assembly.

3. The method of claim 1, wherein said glass body includes one material selected from group consisting of glass, fiberglass and spanger.

4. The method of claim 1, wherein said heat distribution measuring device is a thermography unit.

5. The method of claim 1, wherein heat loss has units of kilowatt/square foot or therms/square foot.

6. The method of claim 1, wherein heat gain has units of kilowatt/square foot or therms/square foot.

7. The method of claim 1, wherein said glass heat loss value or said glass heat gain value is a real-time value.

8. A method of determining energy savings from a film, said method comprising:
obtaining a glass heat loss value or a glass heat gain value of a glass body by measuring heat loss or heat gain from said glass body using a heat distribution device;
obtaining an assembly heat loss value or an assembly heat gain value of a film and glass assembly by measuring heat loss or heat gain from said film and glass assembly by measuring heat loss or heat gain from said glass body using said or another heat distribution measuring device, and in said film and glass assembly;
subtracting said glass heat loss value from said assembly heat loss value to obtain a film heat loss value or subtracting said glass heat gain value from said assembly heat gain value to obtain a film heat gain value;
multiplying said film heat gain value or said film heat loss value with a price per unit of energy to obtain a money savings from heat gain value or a money savings from heat loss value; and
wherein said film and glass assembly includes a film component and a glass component, said film component directly contacts said glass component or is a certain distance off from said glass component and said glass component is same as or similar to said glass body, and wherein said money savings from heat gain value or money savings from heat loss value represent energy savings realized from a film.

9. The method of claim 8, wherein said film component is secured on a fenestration assembly.

10. The method of claim 9, further comprising determining a payback period for cost of purchasing and installing said fenestration assembly based upon said money savings from heat gain value or money savings from heat loss value.

11. The method of claim 8, further comprising determining a lease period for leasing said fenestration assembly based upon cost of purchasing and installing said fenestration assembly and money savings from heat gain value or money savings from heat loss value.

12. The method of claim 10, further comprising determining a lease period for leasing said fenestration assembly based on payback period.

13. A method of determining energy savings from a film, said method comprising:
obtaining a film heat loss value or a film heat gain value for a film, which is part of a glass assembly that includes a film component and a glass component; and
multiplying said film heat gain value or said film heat loss value with a price per unit of energy to obtain a money savings from heat gain value or a money savings from heat loss value;
wherein said film and glass assembly includes a film component and a glass component, such that said film component directly contacts said glass component or is a certain distance off from said glass component and said glass component is same as or substantially similar to said glass body, and wherein said money savings from heat gain value or money savings from heat loss value represent energy savings realized from a film.

14. The method of claim 13, wherein said obtaining includes performing measurement and verification.

15. A method of determining luminous efficacy of a glass body component and film component assembly, said method comprising:
obtaining an assembly visible light transmission value of an assembly of a glass body component and a film component by measuring visible light transmission through said assembly using a visible light transmission measuring device;
obtaining an assembly heat transmission value of said or another assembly of said or another glass body component and said or another film component by measuring heat transmission through said assembly or said another assembly using a heat distribution measuring device;
dividing said assembly visible light transmission value with said assembly heat transmission value to determine an assembly luminous efficacy value;
wherein said another assembly is substantially similar to said assembly.

16. The method of claim 15, wherein said visible light transmission measuring device is a candle meter.

17. The method of claim 15, wherein said heat distribution measuring device is thermography unit.

18. The method of claim 15, further comprising:
obtaining another assembly heat transmission value of a second assembly of a second glass body component and a second film component by measuring heat transmission through said second assembly using a heat distribution measuring device; and
multiplying said another assembly heat transmission value with said assembly luminous efficacy value to determine another assembly visible light transmission value;
wherein in said second assembly, said second glass body component is same as or substantially similar to said or said another glass body component, and said second film component is same as or substantially similar to said or said another film component, and said second assembly is of same or of substantially similar configuration as said or said another assembly.

19. The method of claim 15, further comprising:
obtaining another assembly visible light transmission value of a second assembly of a second glass body component and a second film component by measuring visible light transmission through said second assembly using a visible light transmission measuring device; and
dividing said another assembly visible light transmission value with said assembly luminous efficacy value to determine another assembly heat transmission value;
wherein in said second assembly, said second glass body component is same as or substantially similar to said or said another glass body component, and said second film component is same as or substantially similar to said or said another film component, and said second assembly is of same or of substantially similar configuration as said or said another assembly.
